(19) United States
(12) Patent Application Publication
(10) Pub. No.: US 2005/0105709 A1
(43) Pub. Date: May 19, 2005

(54) Method and system for intelligent routing of telephone calls

(75) Inventors: Frederic Dutronc, Chaville (FR); Florent Bonneau, Meudon (FR); Pierre Mouminoux, Paris (FR)

Correspondence Address: COHEN, PONTANI, LIEBERMAN & PAVANE;Suite 1210, 551 Fifth Avenue, New York, NY, 10176, US

(73) Assignee: France Telecom, Paris (FR)

(21) Appl. No.: 10/919,199

(22) Filed: Aug. 16, 2004

(30) Foreign Application Priority Data
Aug. 21, 2003 (FR) 03 10084

(51) Int. Cl. H04M 7/00

(52) U.S. Cl. 379/221.01; 379/220.01

(57) ABSTRACT

A method of intelligent routing of telephone calls and a system for implementing the method. The method of intelligent routing of telephone calls includes, during a first or configuration step, assigning an identification number to a user who may be called on at least one telephone network and then, during a second or processing step, establishing a relation between these unique identification numbers and a list of telephone call numbers constructed automatically and dynamically and corresponding to various telephone terminals near which the user is located.

### FIELD OF THE INVENTION

The present invention relates to a method of intelligent routing of telephone calls. It also relates to a system for implementing the method of the invention.

### BACKGROUND OF THE INVENTION

There are situations in which a person may be in one or another of several places equipped with telephone connection resources. Unfortunately, a telephone terminal is connected to a telephone network by a single call number. Whatever the form in which address books store a telephone number, the number is generally stored in relation to a single person. Thus if a called person is at a different telephone terminal, the telephone network needs to include a resource for transferring the call to the other telephone. As the number of workstations at which the called person may happen to be located increases, the address books of corresponding callers become unmanageable and the systems for managing telephone calls become unusable.

If the instantaneous location of the user is not known, current telephone management services make successive call attempts to the user's various telephone terminals. The successive call attempts are effected in a static manner and in accordance with fixed parameters, which fails to take account of the user's real situation.

The problem with existing systems is that they always require users to undertake a massive parameter setting effort in order to inform the system of the telephone or telephones at which they are able to receive calls. This declaration aspect is a brake on the use of such systems, even when systems are able to achieve the same level of service by means of complex and repetitive actions. It is no longer possible to speak of a service that is intelligent, since it is the intelligence of users that is called upon, in order to declare their new situations at any given time. Users will miss calls if they forget to establish correspondence between their current situations and that which is known to the system.

To implement the service, prior art systems also require interaction between the user and the system for routing incoming call.

Another problem of prior art systems is their use of network resources. They use telephone call forwarding operations to locate users and a succession of such operations if called users have several telephone terminals. A call will be subjected to the entire chain of call transfers without successful completion of the call being guaranteed, for example if the called user is out or is already busy with another call.

Finally, prior art call transfer systems offer solutions that the user must combine manually to cover requirements in full. Such systems are not mutually consistent, and they are also complex and difficult for the user to use; they are not at all intelligent.

### OBJECT AND SUMMARY OF THE INVENTION

An object of the present invention is to remedy these drawbacks of the prior art.

One aspect of the invention is directed to a method of intelligently routing telephone calls. During a first or configuration step, a personal telephone number is assigned to a user who may be called on at least one telephone network. The assigned personal telephone number is associated with a plurality of telephone numbers assigned to different telephone terminals of the user. During a second or processing step, during a telephone call to the personal telephone number assigned to the user, the user is located, and the telephone call is routed to at least one of the telephone terminals near which the user has been located.

In the example described herein, the user is assigned a unique personal telephone number. The method preferably relates this unique identification number to one or more telephone numbers corresponding to various telephone terminals determined automatically and dynamically depending on the location of the user, and gives preference to routing telephone calls to at least one of the telephone terminals near which the user has been located.

Another aspect of the invention is directed to a system for managing the intelligent routing of telephone calls. The system includes a database server capable of storing a database including a telephone identification number assigned to a user, the assigned telephone number being associated with a plurality of telephone numbers assigned to different telephone terminals of the user. A system for locating the user, at the time of a call associated with a number assigned to a user, establishes a correspondence between the telephone number assigned to the called user and the at least one telephone number of the located telephone terminal. A telephone call communication means routes the telephone call to at least one of the telephone terminals at which the user has been located.

The database stored in the database server is preferably kept up to date.

Another aspect of the invention is directed to an article of manufacture for use in a telephone call routing system, including a computer usable medium, wherein the computer readable medium comprises a computer readable code means having code instructions which, when executed in a call routing device, cause the following: storing a database including a telephone number assigned to a user, said assigned telephone number being associated with a plurality of telephone numbers assigned to different telephone terminals of the user; establishing, during a call associated with the number assigned to a user, the correspondence between the telephone number assigned to the called user and the at least one telephone number of the previously-located telephone terminal; and routing telephone calls to at least one telephone terminal near which the user has been located.

Unlike prior art location systems, the present invention routes calls to users intelligently and automatically. There is no list of telephones assigned to a particular user. A unique assigned telephone number is preferably sufficient to implement the invention; thus the invention stores only one telephone number, which is the number assigned to the user during the storage step.

The location system preferably operates instantaneously, so that a relation is established instantaneously, at the time of a telephone call, between a telephone number assigned to the called user and the telephone number of the telephone terminal associated with the user's location.

In the example described herein, the telephone terminals may be associated with workstations (or computer terminals) which may be related to the user registered in the database. Advantageously, the method of the invention includes a step of detecting activity at a computer terminal associated with a particular telephone terminal. Calls are thus routed to the telephone numbers of users as a function of the computer activity of said users.

The invention also separates the static information into two databases listing, firstly, the users and their unique personal numbers and, secondly, the “hardware perimeter” of the service with the computer and telephone networks. It is the system of the invention that dynamically constructs a link between the two databases. The present invention determines to which telephone terminal calls to a user should be routed as a function of the user's activity, for example activity at a computer terminal associated with a particular telephone terminal.

Note that the various servers and databases and the location system may be installed on the same device or divided between a plurality of devices.

### BRIEF DESCRIPTION OF THE DRAWINGS

Other features and advantages of the present invention will be better understood in the light of the following description and the appended drawings, in which:

FIG. 1 is a flowchart of the method of the invention;

FIG. 2 shows an embodiment of the system of the invention; and

FIG. 3 shows another embodiment of the system of the invention.

### DETAILED DESCRIPTION OF THE DRAWINGS

In the context of the present invention, in order to provide intelligent telephone call routing services, each user is initially assigned a telephone number that is used to contact the user independently of physical location. This telephone number is preferably a unique and personal telephone number. The improvement effected by the present invention is to use the computer connection properties of a user to determine the telephone terminal to which to route calls for the user. In the context of the present invention, the intelligent routing of telephone calls is made possible by the provision of location means as the means for detecting the presence of the person. The invention thus executes a first step of automatically locating the user in relation to a fixed or mobile telephone terminal.

One possible application of the invention enables its implementation in a business whose offices are not assigned to individual employees. Each office has a data processing terminal or station that is preferably connected to a business local area network or to an external network such as the Internet. Where appropriate, each office also has one or more telephone terminals connected to a telephone network, which may be separate from, the same as, or combined with the local computer network or the external network such as the Internet. Using the invention, it is possible to assign offices and workstations of the business dynamically as a function of the requirements of users. For example, the mere fact that the user opens a work session at a computer terminal enables the present invention to route calls for that user to a telephone terminal adjacent the computer concerned.

Another application of the invention implements managing of the work of peripatetic workers equally likely to be working at home, in a temporary office, or in an office of their own. The call routing system of the invention comprises remote means enabling a peripatetic worker to connect to the business private network from home, enabling the present invention to route all business calls for that user to a home telephone terminal, without requiring any intervention by the user.

For example, when peripatetic users are working at home, they must inform the call routing system that they are now at home, in order for the system to be able to route calls for them in their home telephone terminals. The appropriate location may be given in various ways. The call routing system includes means for calling an interactive voice server, means for calling a connection to an Internet site, means for automatically sending messages over a mobile telephone network, such as SMS messages, and means for automatically sending codes to the computer system (PABX) managing the telephone network of the business.

Thus, depending on the circumstances detected by the call routing system, a call to a personal number may advantageously be directed: to a business telephone terminal, to a private telephone terminal, to a mobile telephone terminal, or to a voicemail service, as a function of the actual physical location of the called person at the time of the call.

One particular embodiment of the routing system of the invention includes means for identifying the telephone number used for an ADSL connection used by a peripatetic user working at home, and for using this number as the telephone number to which the routing system may direct calls incoming to the telephone network of the business, in particular when the routing system has detected peripatetic activity in relation to the ADSL connection.

In one particular embodiment, when a peripatetic user is working at home, that user cannot be located directly by the direct means of the routing system. In the embodiment described, the routing system includes means for cooperating with additional means available to the peripatetic worker for specifying location. Such means include automatic means such as means for automatically sending messages over a mobile or fixed telephone network, such as SMS messages, means for automatically sending codes to the computer system managing the telephone network of the business with which the peripatetic worker is associated, such as a private automatic branch exchange, and semi-automatic means such as an interactive voice server activated on the first connection of the peripatetic worker to the home computer system and/or telephone system or on access to an Internet interface.

One particular embodiment of the method of the invention takes account of other data to form the call routing criteria, such as data relating to the use of time of the called person, the identity of the calling person, or even the activity of the called person at his computer terminal.

It is not always possible to obtain or verify information concerning the location of a user. These elements effectively complement the routing system of the invention to determine the location of users in complex situations or situations where there is a lack of information, for example when there is no connection to a computer terminal.

One benefit of the present invention for users is that it routes calls for them to the most appropriate telephone terminal without requiring any intervention from them to set parameters. It suffices for them to log onto a computer for their calls to be routed automatically to a telephone terminal adjacent the computer. The present invention may be implemented for incoming calls for a “located” user.

The present invention may be used to generate calls for the user from the telephone at which the routing system will automatically locate that user.

In one particular embodiment, a telephone call is generated automatically by an automatic call routing system of the remote Telephone Computer Coupling (TCC) type. The calling automatic system communicates with an application running on the computer terminal of the user. For example, the user working on a computer terminal with which a telephone terminal is associated may have clicked on a hypertext link to an Internet address monitored by the automatic call routing system. The automatic call routing system locates the user as a result of clicking on the link. By reading personal data associated with the application running on the computer terminal connected to the automatic call routing system via the Internet, the system determines the user's number and places a call progression sequence at the user's address, for example using a click to dial service.

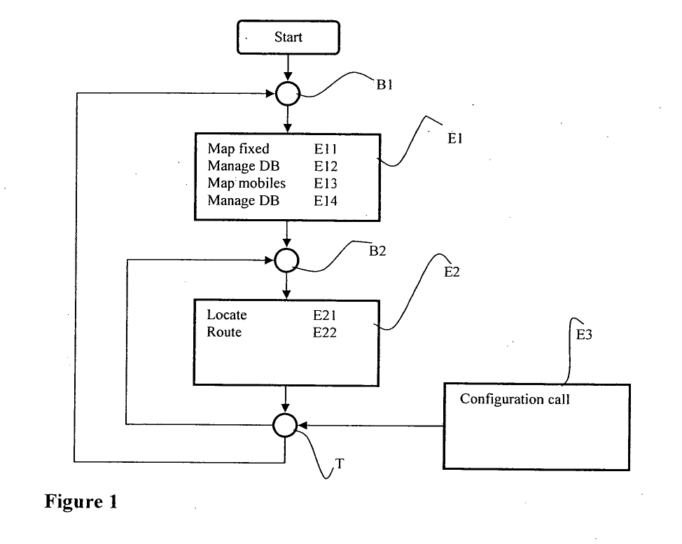

FIG. 1 is a flowchart of an implementation of the method of the invention. A first step E1 of the method of the invention consists in mapping the telephone and computer networks and configuring the computer and telephone systems on which users may be called.

It will be noted that the configuration process of step E1 comprises two separate configuration operations: firstly configuring users and their unique personal numbers, and secondly configuring the telephone and computer systems at which the users may be located and called. The configuration of the telephone and computer networks is static and independent of the users, but may be modified as networks evolve.

Then, during a sub-step E21 of a step E2 of processing incoming telephone calls, the method of the invention locates each user registered during the step E1 and, during a sub-step E22, routes incoming calls on the managed telephone networks to the most appropriate telephone terminals.

In this embodiment, the configuration loop is initialized to a state B1 and may be relaunched on each end-of-loop test T. For example, the reconfiguration operation may be relaunched in a configuration request step E3. The test T and one of the evaluation conditions effected in step E3 should be considered in a manner that is not correlated with the location and routing processes.

In a working environment, a fixed computer terminal (desktop computer) is generally associated with a fixed telephone terminal. If a user is active at the computer terminal, that user may be contacted on the adjacent telephone terminal, or on one of the adjacent telephone terminals if there is more than one. A mechanism described below shows how to select a telephone terminal from “n” adjacent telephone terminals (where “n” is the number of adjacent terminals). The user is said to be located at the telephone terminal in question. Fixed terminals of this kind may be used by different users and are not necessarily personalized. They are computers made available in temporary offices, for example. Using a standard authenticated procedure at the computer terminal, the system of the invention associates the user with the computer terminal and then with the adjacent telephone terminal.

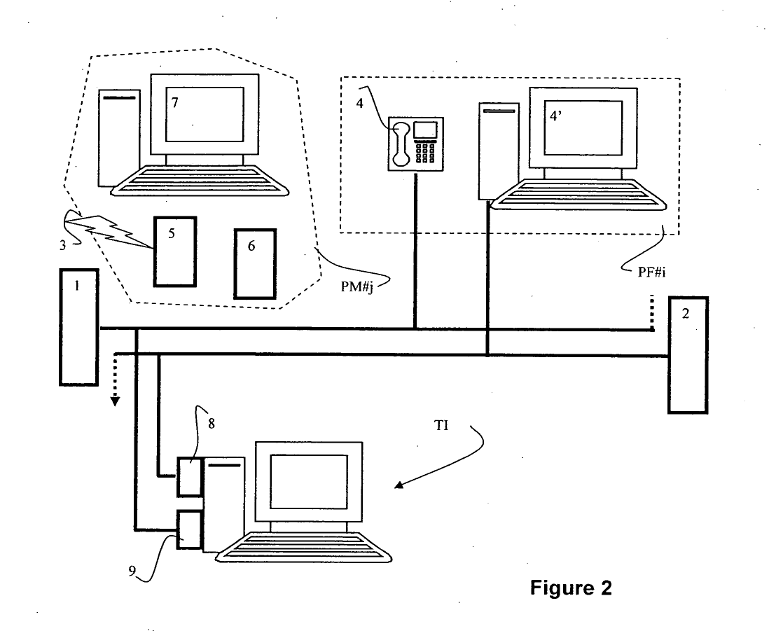

FIG. 2 shows an embodiment of a system using the method of the invention. A fixed telephone network on the premises of a business is connected to a private automatic branch exchange 1. A computer local area network on the premises of the business is connected to a server 2. In a plurality of fixed workstations PF#i each comprising a telephone terminal 4 and a computer terminal 4′, the telephone terminal is connected via a local connection to the private automatic branch exchange 1 and the computer terminal 4′ is connected via its connection to the business local area network to the server 2. A plurality of mobile workstations PM#j are provided, each comprising a computer terminal 7, a personal digital assistant 6, and a mobile terminal 5. The mobile terminal 5 is connected in a manner that is known in the art to the mobile telephone network 3 and the computer terminal 7 and/or the personal digital assistant may be connected to the business local area network via an Internet connection or a peer to peer connection. The mobile workstations PM#j may be on the premises of the business or elsewhere.

Finally, a computer terminal TI is provided in relation to the above networks, and where appropriate comprises a connection 8 to the business local area network to enable it to reach the computer terminals of the fixed workstations TF#i and/or to the Internet to enable it also to reach the computer terminals of the mobile workstations TM#j, and further comprises a connection 9 to the fixed telephone network for executing TCC type functions, for example.

In the case of a mobile computer terminal, association with a telephone terminal is also possible, for example:
either by means of a dynamic environment detection system (for example a BlueTooth™ channel), for determining the nearest, the most pertinent telephone;
or by association with the user's mobile telephone.

A user may be located at a plurality of workstations or at a plurality of telephone terminals, for example a mobile telephone terminal and a fixed telephone terminal. In this case, the call routing system effects a succession of call attempts to the various terminals, sequentially, and in accordance with a predetermined priority mechanism, until one of the terminals responds favorably.

In the case of sequential routing, the system must define the order in which the terminals are called, which order may be defined as a function of a plurality of criteria:
detection of activity at the computer station associated with the telephone terminal, as mentioned above;
the types of terminals, selected from a predetermined list, e.g. fixed, priority, mobile, etc.

An embodiment of the invention is described above in which routing selection is sequential. Simultaneous routing may be employed in a different embodiment of the invention.

In the embodiment described, the method of the present invention comprises the following operations or steps separately or in combination:
1. In a sub-step E11 of configuration step E1 (see FIG. 1), mapping the associations between fixed computer terminals and fixed telephone terminals, and then storing these associations in a database during a sub-step E12 of configuration step E1 (see FIG. 1).
2. Defining the users and their unique personal number and storing this information in a database.
3. Defining the mobile telephone terminals of the users during a sub-step E13 of step E1 (see FIG. 1), and then storing this information in a database during a sub-step E14 of configuration step E1 (see FIG. 1).
4. Monitoring connections to the computer terminals and the activity of authenticated users at the computer terminals. This kind of monitoring may be carried out in various ways: monitoring computer sessions, monitoring the real activity of users (counting the number of keystrokes per unit time period, detecting the times of movements of a pointing device such as a mouse), or executing a dedicated application.
5. Routing calls received for personal numbers to the telephone numbers at which users having the personal number have been located, preferably as a function of the computer activity of said users.

The system of the present invention therefore comprises two sub-systems:
A first sub-system is responsible for collecting information for determining the location of users intelligently and automatically.
A second sub-system uses the intelligent and automatic user location information to provide an optimized and efficient connection service.

The present invention may be associated with other systems acting as sources of information and the call processing criteria may include other parameters:
location based on information taken from the user's appointments diary;
routing to a terminal or message service depending on the identity of the caller;
taking account of the instantaneous availability expressed by the user.

These elements then complement the intelligence of the system to yield more refined user selection using information that does not have to be entered for direct setting of parameters of the invention.

An embodiment of the routing system also includes means for storing and using default parameters for routing a call to a default telephone terminal or to a mobile telephone if no computer activity has been detected.

An embodiment of the routing system further includes means for informing a user of that user's telephone location, in particular by signaling on signaling means the telephone to which that user's calls will be routed, and means enabling the user to modify the telephone location as determined automatically by the system if the result does not suit the user.

An embodiment of the system of the invention uses the following elements. Each user is assigned a personal number, preferably a unique number, used by contacts to call him or her. This number does not correspond to any particular telephone, but is assigned to the user. This embodiment of the call routing system of the invention comprises:
a private automatic branch exchange (PABX) with its own computer system handling standard telephone management functions;
a Telephone Computer Coupling (TCC) server capable of controlling the private automatic branch exchange and performing complementary telephone operations such as putting calls on hold, transferring calls, etc.;
an application server using service logic to determine how to route calls;
a presence server responsible for collecting user activity and connection information coming from computer terminals managed by the system and for keeping the user presence and location status up to date; and
a database for storing associations between computer terminals and telephone terminals (and also able to store other data such as user preferences, default telephones of a user, etc.).

Each incoming call to a user registered in the database of the routing system of the invention is directed by the PABX to the TCC server, which advises the application server of the arrival of the call using an appropriate protocol. The transmitted parameters include at least the called personal number and the number of the calling party, if available.

In this example, the application server then performs the following operations:
1. It requests the TCC server to place the call on hold.
2. Using an appropriate protocol, it asks the presence server for the current telephone location information for the user associated with the called personal number.
3. The presence server verifies that the user in question is actually present and active on a computer, and recovers from the database the telephone number associated with the computer that is being used. If the user is not detected at any machine, the presence server determines the default telephone for the user (mobile telephone, usual office telephone, etc.). The presence server sends the application server the current telephone location of the user.
4. It requests the TCC server to transfer the incoming call to the telephone at which the user is located.

The application server may also use other call routing criteria, such as the user's appointments diary or the identity of the caller. Such services are already known and used in the art and do not constitute the subject matter of the present invention. However, taking them into account and using data found in them in the context of the intelligent routing method complements and adds value to such existing services.

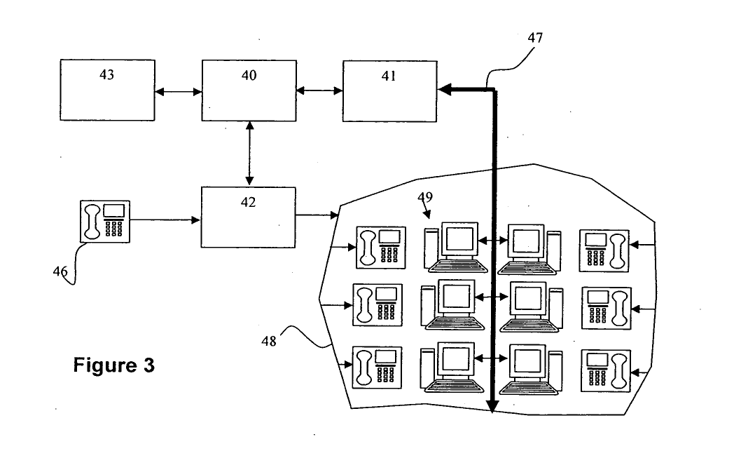

FIG. 3 is a diagram showing the various elements used above to explain the invention, namely:
1. A database server 43 dedicated to storing:
   a. A list of computer terminals managed by the system.
   b. For each of those computer terminals, whether it is a fixed or a mobile terminal.
   c. For each fixed computer terminal, the address of the adjacent fixed telephone terminal, if there is one, or of each of the adjacent fixed telephone terminals if there are several.
   d. A list of users of the system.
   e. For each user, the address of their personal mobile telephone terminals.
   f. For each user, a personal telephone number, preferably a unique number.
   g. For each mobile telephone terminal, whether it is dedicated to a personal user or a business user.
   h. For each user, an address of a preferred telephone terminal for that user, to which calls for that user will be routed in the absence of reliable information concerning the presence of the user.
2. A presence server 41 for monitoring the activity of users at the computer terminals managed by the system and for keeping the presence status of each user up to date. It is connected to the computer network 47 of the business.
3. A call monitoring server 42 for taking charge of all telephone calls to the personal numbers of users. On receiving an incoming call, it alerts an application server 40. Controlled by the application server 40, the call monitoring server 42 comprises means for putting on hold incoming calls such as those coming from a calling telephone terminal 46, means for launching a call to the destination telephone terminal, and means for terminating both calls.
4. An application server 40 comprising means for implementing the service logic and means for managing the routing of incoming calls. It uses data supplied by the database 43 and presence detection data supplied by the presence server 41, data of both kinds being processed by means for determining the telephone terminal to which the call should be routed. Where applicable, the telephone terminal may be a voicemail device or some other device of this kind. The application server 40 may also comprise means for implementing more sophisticated service logic additionally taking account of the appointments diary of the called person recovered via a connection to a diary management tool, for example.

The present invention may equally use a voice server acting on the instructions of the application server and may be responsible for broadcasting recorded messages.

1. A method of intelligently routing telephone calls, comprising:
during a first or configuration step, assigning a personal telephone number to a user who may be called on at least one telephone network, said assigned personal telephone number being associated with a plurality of telephone numbers assigned to different telephone terminals of the user; and
during a second or processing step, during a telephone call to said personal telephone number assigned to the user, locating the user and routing the telephone call to at least one of the telephone terminals near which the user has been located.

2. A method according to claim 1, wherein said personal telephone number assigned to the user is a unique number.

3. A method according to claim 1, including a step of detecting activity on a computer terminal associated with a particular telephone number and wherein calls are routed to the personal numbers of users as a function of the computing activity of said users.

4. A method according to claim 1, wherein the processing step includes a sequential routing step with prioritization of terminals by the user or by the system according to their type (fixed, mobile, etc.), or a simultaneous routing step with interruption of other call attempts immediately a first call attempt succeeds.

5. A method according to claim 3, including the preliminary step of mapping, in a sub-step of the configuration step, the associations between computer terminals and telephone terminals, and then storing these associations in a database during a sub-step of the configuration step.

6. A system for managing the intelligent routing of telephone calls, the system comprising:
a database server for storing a database including a telephone number assigned to a user, said assigned telephone number being associated with a plurality of telephone numbers assigned to different telephone terminals of the user;
a system for locating the user, at the time of a call associated with a number assigned to a user, to establish a correspondence between said telephone number assigned to the called user and said at least one telephone number of the located telephone terminal; and
telephone call communication means for routing the telephone call to at least one of the telephone terminals at which the user has been located.

7. A system according to claim 6, wherein said personal telephone number assigned to the user is a unique number.

8. A system according to claim 6, including means for detecting activity on a computer terminal associated with a particular telephone terminal and wherein calls are routed to the personal numbers of users as a function of the computing activity of said users.

9. A system according to claim 8, including means for detecting the opening of a working session at the computer terminal associated with a particular telephone terminal, such session opening corresponding to activity by a user, so that calls for that user are routed to the telephone terminal near that computer terminal.

10. A system according to claim 8, including a presence server for collecting user activity and connection information coming from computer terminals managed by the system and for keeping the presence and location status of users up to date.

11. A system according to claim 8, further including means for informing a user of that user's telephone location, in particular by signaling on signaling means the telephone to which that user's calls will be routed, as well as means enabling the user to modify the telephone location as determined automatically by the system if the result does not suit the user.

12. An article of manufacture for use in a telephone call routing system, including a computer usable medium, wherein the computer usable medium comprises a computer readable code means having code instructions which, when executed in a call routing device, cause the following:
storing a database including a telephone number assigned to a user, said assigned telephone number being associated with a plurality of telephone numbers assigned to different telephone terminals of the user;
establishing, during a call associated with the number assigned to a user, the correspondence between said telephone number assigned to the called user and at least one telephone number of a telephone terminal which has been located beforehand; and
routing telephone calls to at least one telephone terminal near which the user has been located.
